(19) United States
(12) Patent Application Publication
(10) Pub. No.: US 2008/0232549 A1
(43) Pub. Date: Sep. 25, 2008

(54) System and Method For Dual Energy Dynamica X-Ray Imaging

(75) Inventor: Tim Poorter, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/063,037

(22) PCT Filed: Jul. 14, 2006
(86) PCT No.: PCT/IB06/52410

§ 371 Date: Feb. 6, 2008

Related U.S. Application Data
(60) Provisional application No. 60/706,863, filed on Aug. 9, 2005.

(51) Int. Cl. H05G 1/64

(52) U.S. Cl. 378/98.9

(57) ABSTRACT

A system and method for dual energy imaging in dynamic imaging sequences is disclosed. The system and method includes a x-ray source (204) configured for fast adaptation at different kV values of the x-ray source (204); a flat x-ray detector (202) having parallel signal integration and read-out; and a x-ray controller (206) in operable communication with the x-ray detector (202) and x-ray source (204). The detector (202) integrates a first signal corresponding to a first sub-image (300) at a first kV value (302), transfers the integrated first signal to a sample and hold node for each pixel and integrates a second signal corresponding to a second sub-image (304) at a second kV value (306). The detector (202) provides signal integration of the second sub-image (134) in parallel with read-out of the first sub-image from the sample and hold nodes. (300). The x-ray controller (206) controls generation of x-ray pulses in the x-ray source (204) and acquisition of images with the x-ray source (204) generating the x-ray pulses at different kV values on a millisecond timescale.

The present disclosure relates generally to dual energy imaging and in particular, to a method and system for dynamic dual energy imaging, and, more particularly, to such a dynamic dual energy imaging system and method employing dual (i.e., two different) x-ray energies, obtained by rapidly switching an x-ray energy source between low and high energy levels, and using a single large area pixelated digital x-ray detector to capture the resulting and respective, dual energy x-ray images. The dual energy images are processed, with a pre-calibrated database and adjustable parameters, to produce respective, and separate, images affording enhanced visibility of an anatomy of interest, facilitating x-ray imaging during cardio/vascular applications, for example.

The usage of x-ray systems in clinical imaging and diagnosis enjoys widespread acceptance. Several types of x-ray imaging methodologies may be employed to image different anatomical areas or to provide differing diagnostic tools. One such x-ray imaging methodology is dual energy (DE) imaging. It is known that additional imaging contrast can be obtained when DE imaging is used.

Dual energy (DE) is a clinical application wherein two x-ray images are acquired at different x-ray energies. The two x-ray images are then combined to provide tissue-subtracted images, e.g., soft tissue and bone images. One clinical application of DE is diagnosis of plaque in the coronary arteries with x-ray. In practice, the soft tissue image improves sensitivity by removing the structured noise due to the bones, and the bone image improves specificity by showing if an artery is vulnerable to plaque.

With flat panel x-ray detector technology, the two x-ray images are typically successively acquired with two separate x-ray exposures at different energies. In order to minimize patient motion artifacts between the two x-ray images, the time between the x-ray images is typically minimized (typically on the order of 200 ms). In order to minimize diaphragm motion, the patient is typically asked to hold their breath. However, involuntary patient motion, such as the contraction of the heart, cannot be avoided. Significant motion of the heart between the two x-ray images may yield poor image quality due to imperfect tissue cancellation in the subtracted images. The poor image quality may lead to possible missed arteries having plaque surrounding the heart.

Additionally, in conventional x-ray imaging systems for dynamic imaging, the image acquisition, the dose control and the image read-out are much too slow to use different kV values for the x-ray source in one image (e.g., with 2 or more sub-images). This means that dual energy imaging in dynamic imaging sequences is not possible.

Thus, a need has long been felt for a system and method that provides for better diagnostic dynamic x-ray imaging. Specifically, a need has long been felt for an improved diagnostic dynamic x-ray imaging system for employing DE. Further, a need has long been felt for such an improved DE system that minimizes the effect of involuntary patient motion in the resultant x-ray images and permit dynamic imaging sequences in order to improve imaging contrast and consequent diagnosis in real time.

The present disclosure provides a system for dual energy imaging in dynamic imaging sequences. The system includes a x-ray source configured for fast adaptation at different kV values of the x-ray source and a flat x-ray detector having parallel signal integration and read-out. The detector (202) integrates a first signal corresponding to a first sub-image (300) at a first kV value (302) and a second signal corresponding to a second sub-image (304) at a second kV value (306). The detector (202) provides signal integration of the second sub-image (134) in parallel with read-out of the first sub-image (300). The x-ray controller (206) controls generation of x-ray pulses in the x-ray source (204) and acquisition of images with the x-ray source (204) generating the x-ray pulses at different kV values on a millisecond timescale.

The present disclosure also provides a method of dual energy dynamic x-ray imaging. The method includes: obtaining images at a selected frame rate, each image includes a first sub-image (300) and a second sub-image (304); integrating a first signal corresponding to the first sub-image (300) in a few milliseconds at a first kV value (302); transferring the integrated first signal corresponding to the first sub-image (300) to a sample and hold node for each pixel of a CMOS flat detector (202); increasing an x-ray tube voltage to a preset second kV value (306) higher than the first kV value (302); resetting the detector (202)in less than about 1 millisecond; and reading out the first image (300) while the second kV value (306) is obtained and in parallel with the flat detector (202) integrating a second signal corresponding to the second sub-image (304).

Additional features, functions and advantages associated with the disclosed system and method will be apparent from the detailed description which follows, particularly when reviewed in conjunction with the figures appended hereto.

To assist those of ordinary skill in the art in making and using the disclosed system and method, reference is made to the appended figures, wherein:

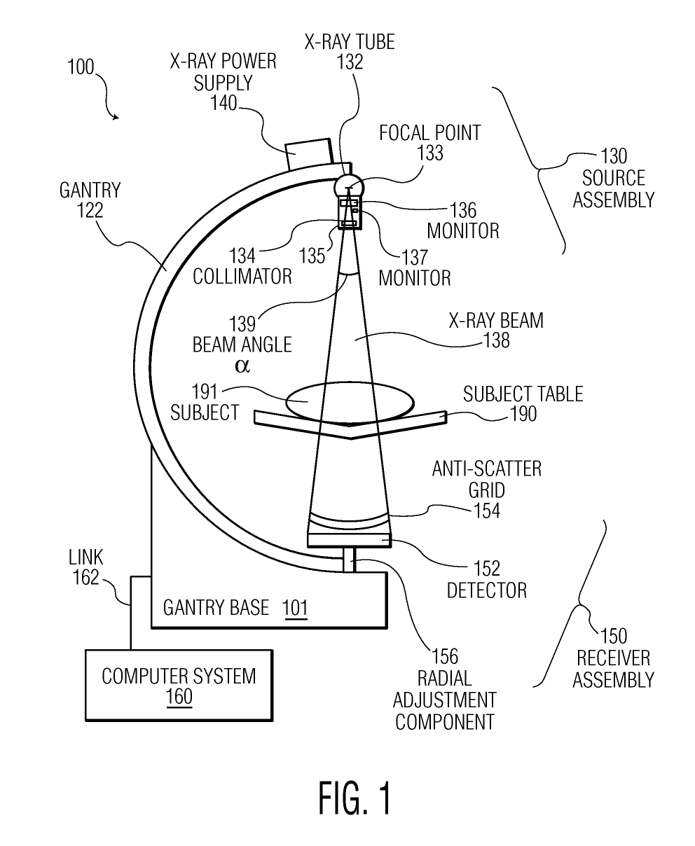

FIG. 1 is a block diagram illustrating structural components of an apparatus for dual-energy dynamic x-ray absorptiometry, according to an exemplary embodiment of the present disclosure;

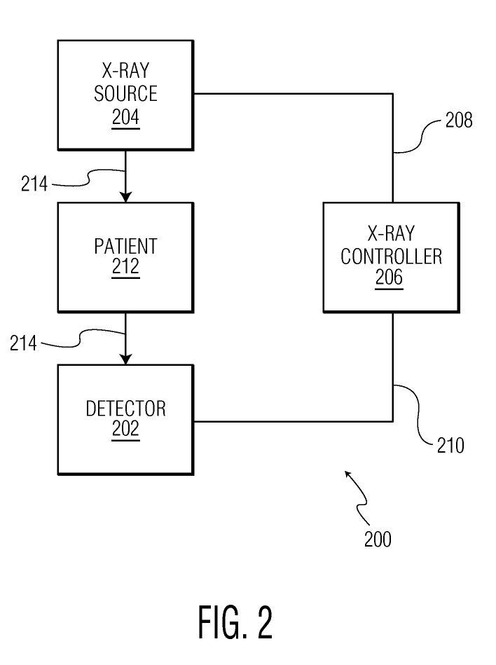

FIG. 2 illustrates a block diagram of an x-ray source, detector and x-ray controller used in a dual energy x-ray imaging in an exemplary embodiment of the present disclosure; and

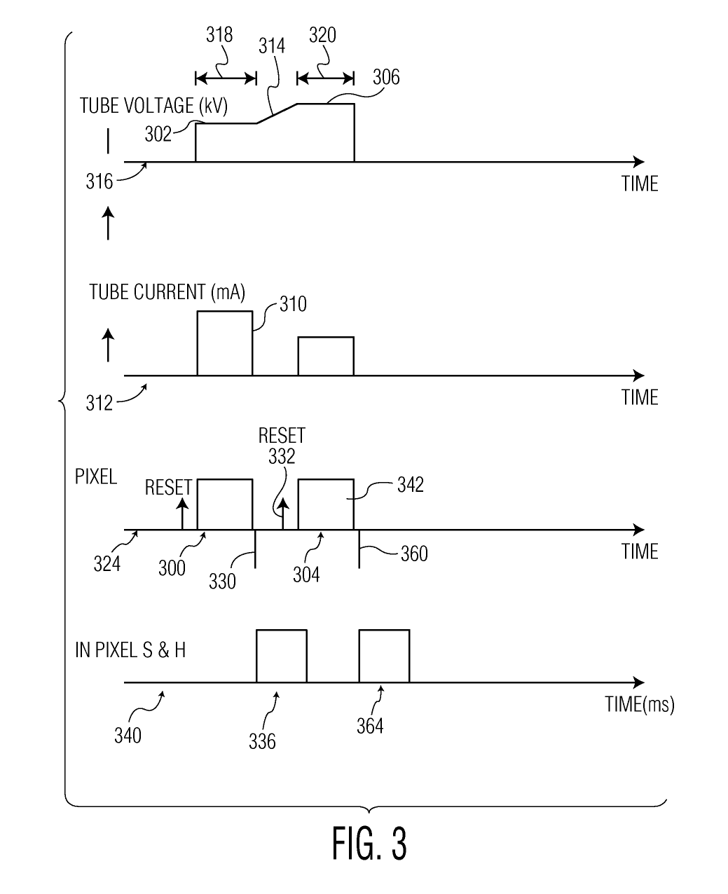

FIG. 3 illustrates four graphs of tube voltage, tube current, integration and read-out of first and second pulses, respectively versus time in an exemplary embodiment of the present disclosure.

As set forth herein, the present disclosure advantageously facilitates dual energy dynamic imaging and improves contrast in tissue without using or using less contrast medium. The present disclosure may be advantageously employed in cardio applications including visualization of vulnerable plaque in cardiac arteries, for example. The use of dual energy sub-images acquired at very small time intervals at different kV values of the x-ray source leads to the improved contrast without using or using less contrast medium. When the sub-images made at different kV values are subtracted or divided, dual energy images are obtained in each frame of a dynamic sequence.

FIG. 1 is a block diagram illustrating structural components of an apparatus 100 for dual-energy dynamic imaging, according to an embodiment. The cross section of FIG. 1 defines an X-Z plane in which Z is the vertical dimension and X is the horizontal dimension. A horizontal dimension extending out of the page, perpendicular to the X-Z plane, is the Y dimension.

The apparatus includes a gantry 122 shaped to hold an x-ray source assembly 130 in fixed relation to a receiver assembly 150. An x-ray beam 138 is emitted from source assembly 130 to receiver assembly 150. In one embodiment, a centerline of beam 138 lies in the X-Z plane. The gantry is moveably attached to a gantry base 101 so that source assembly 130, receiver assembly 150, and beam 138 centerline rotate in the X-Z plane about an axis line in the Y dimension. The rotation preserves the distance and relative directions between source assembly 130 and receiver assembly 150. In other embodiments, the locations of source assembly 130 and receiver assembly 150 on the gantry are exchanged, so that the source lies below the subject and the receiver lies above. In other embodiments, the gantry has other shapes, such as an annular shape.

A subject table 190, transparent to x-rays, is disposed between source assembly 130 and receiver assembly 150 in the X-Z plane. Subject table 190 supports a subject 191 during operation of apparatus 100. Either the subject table 190 or gantry base 101 or both are configured to translate in the Y dimension so that different portions of subject 191 intersect the X-Z plane. In some embodiments, the subject table may also rotate in an X-Y plane about an axis line in the Z dimension. In other embodiments, the receiver assembly employs a detector large enough in the Y dimension so that the subject table is not translated in the Y direction.

The gantry is connected to a computer system 160 by a communications link 162. Through link 162, computer system 160 controls the motion of gantry 122 and gantry base 101, controls the operation of source assembly 130, and receives data from a detector 152 of receiver assembly 150. In some embodiments, the computer system also controls the movement of the subject table through link 162 or another link, not shown.

Source assembly 130 includes an x-ray power supply 140, an x-ray tube 132 and an x-ray beam-forming component 135. X-rays are electromagnetic waves and a discrete quantum of an electromagnetic wave is a photon. An x-ray with frequency (v) has a photon energy (E) proportional by Plank's constant h; that is, E=h v.

In the x-ray tube, high-energy electrons from a heated filament collide with a material (at a positively charged anode) where the electrons are suddenly decelerated to produce x-rays with a distribution (relative number of photons) per photon energy (frequency) determined by the energy of the incident electrons. A high voltage (V) input, V1, applied between the heated filament and the anode accelerates each electron before the electron collides into the anode. The kinetic energy of a single electron accelerated by a 1-volt electric field is an electron volt (about 1.6.times.10.sup.−19 Joules, or 4.45×10⁻²⁴ kilowatt-hours). To produce x-rays, the voltage V1 is many tens of thousands of volts. The x-ray tube produces x-ray photons with a distribution of photon energies up to a cutoff photon energy determined by the input voltage V1; that is, all x-ray photons have energies less than or equal to a cutoff energy of V1 electron-volts (at cutoff frequency vc). The peak energy (at frequency vp) is the x-ray photon energy that has the most photons; the peak energy is slightly less than V1 electron-volts. The number of photons produced decreases with decreasing photon energy (frequency) below the peak energy (frequency vp).

The x-ray power supply 140 provides the high voltage input, V1, between the heated filament and the anode. The x-ray power supply 140 also provides enough electrons per second, current (I), to supply a useful number of electrons striking the anode. An Ampere of current is 1 coulomb per second, which is about 0.6×10¹⁹ electrons per second. The power provided by the power supply is the product of the current I and the voltage V1. By definition, the unit of the product, an Ampere-volt, is a Joule per second, which by definition is 1 Watt.

In a dual-energy system, the power supply also drives the x-ray tube at a different voltage V2, which causes a different distribution of x-ray energies (frequencies) with a different cutoff energy (at a second cutoff frequency vc2) and a different peak energy (at a second peak frequency vp2).

The x-ray beam-forming component 135 includes a collimator 134 for shaping the beam angle 139 and a filter 136 for limiting the distribution of frequencies about the peak frequency. A monitor 137 is also included to measure x-ray characteristics of the source for changes that may affect calibration and for determining attenuation.

The collimator is made of an x-ray opaque material, such as lead, with an opening (aperture) size and shape selected to give beam 138 a particular cross section in a plane perpendicular to the centerline. The beam angle α, in the X-Z plane across subject 191, may be different from the beam angle β, in the plane containing the centerline of beam 138 and perpendicular to the X-Z plane, along subject 191.

The filter is made of a material that blocks the lower energy x-rays, below the peak energy, passing only x-rays with energies above a high-pass energy (at frequency va). As a result, only a narrow range of x-ray photon energies, from a high pass energy (at va) just below the peak energy (at vp) to the cutoff energy (at vc), emerges from the x-ray source assembly 130. In a dual-energy system, a second filter is used when the power supply drives the x-ray tube at the second voltage V2. The second filter blocks x-ray photon energies below a second high pass energy (at va2), which is less than the second peak energy (at vp2).

The receiver assembly 150 includes detector 152, an optional radial adjustment component 156, and an anti-scatter element, such as anti-scatter grid 154. The detector includes one or more receptors that respond to the x-ray fluence (energy per unit area). The diminution of fluence from the source assembly to a receptor in the detector along any radial line is due to geometrical spreading of the beam, which is easily calculated, and the absorption by subject 191 and subject table 190. The absorption by the subject depends on the photon energy (frequency) of the beam and the material in the subject 191.

The anti-scatter element reduces the number of photons striking the detector from directions other than a radial direction to the detector from a focal point 133 in the x-ray tube. The material in subject 191 and table 190 absorbs some x-ray photons and scatters some in other directions. If these scattered photons strike the detector, the measured intensity is increased and the computed attenuation is erroneously decreased. Estimates of scattering may be made to correct the computation of absorption, but the estimates are both difficult and imprecise. If the scattering can be reduced, both the speed and the precision of the absorption computation can be enhanced. The anti-scatter component is usually made up of an x-ray opaque material, such as lead, with slits aligned perpendicularly to the detector, so that only photons traveling on a perpendicular ray strike the detector 152. Such perpendicular slits eliminate much of the scattering in conventional DE systems. In one embodiment, the anti-scatter grid includes holes arrayed over a spherically curved lead sheet large enough to cover detector 152 and having a radius of curvature that matches the distance from the grid to a focal point 133 in the x-ray tube 132.

The radial adjustment component 156 allows the distance from detector 152 to subject 191 or focal point 133 or both to be changed. It is sometimes advantageous to change these distances. For example, decreasing the distance from subject 191 to detector 152, and increasing the radial distance from receiver assembly 150 to source assembly 130, may allow the entire subject to be imaged at one time. This is one way a full body scan of subject 191 is obtained. The system 100 is then re-calibrated whenever this distance is changed.

In dynamic imaging sequences using conventional x-ray imaging systems, the image acquisition, the dose control and the image read-out are much too slow to use different kV values for the x-ray source in one image (with 2 or more sub-images). This means that dual energy imaging in dynamic imaging sequences has not been possible. However, it has been determined that when the imaging system is changed in a manner described below, dual energy dynamic imaging sequences can be made possible.

In an exemplary embodiment a very fast x-ray detector 152 is used with parallel signal integration and read-out in combination with a very fast adaptation of the kV value of the X-ray tube 132. In addition, the very fast a-ray detector 152 may be equipped with an integrated with dose sensing option. Thus, imaging contrast is improved and dynamic imaging sequences can be viewed such that e.g. vulnerable plaque in cardiac arteries can be made visible in real time, for example.

Referring to FIG. 2, an exemplary embodiment of a dual energy imaging sequence system 200 is schematically depicted. System 200 includes a flat x-ray detector 202 (e.g., detector 152 in FIG. 1) based upon a full area CMOS imager. Detector 202 is configured to provide frame rates well above one hundred frames per second (100 fps) and as high as several thousand fps depending on the pixel size used. Detector 202 includes a buffer storage node or sample and hold node (S& H) in which an integrated signal can be stored synchronously for the total image. In an exemplary embodiment, the storage node is an internal buffer storage node, however, it is contemplated that the storage node may comprise a different layer of a CMOS substrate or that it may comprise a different storage system connected to each pixel by, e.g., bump bonding. Detector 202 is further configured to read-out while a next image is simultaneously being integrated. Detector 202 also includes the ability to run in an integrated dose sensing mode (e.g., operation of a frame rate of as high as 10,000 fps in a course pixel mode while an actual image is integrated in a desire pixel size). In an exemplary embodiment, detector 202 is a CMOS based flat detector (FD) implementing the features described above.

System 200 includes an x-ray source 204 (e.g., tube and generator) in which during operation, the tube voltage of the x-ray tube can be changed, increased or decreased, within a millisecond timeframe (e.g., order of magnitude in a range of about 5 kV/ms to about 100 kV/ms) and have an accurate control of exposure time. Preferably, x-ray tube voltage can be changed in a range of about 20 kV/ms to about 40 kV/ms. Moreover, the tube current can be switched on and off very rapidly and supply requested x-ray doses at different kV values and at precise kV values. X-ray source 204 is akin to x-ray source assembly 130 of FIG. 1.

System 200 further includes an x-ray controller 206 (e.g., computer 160 of FIG. 1) that controls the generation of x-ray pulses via line 208 and the acquisition of images with different tube conditions within a millisecond timeframe via line 210. A patient 212 (e.g., subject 191 of FIG. 1) is shown disposed between x-ray source 204 and detector 202 with x-rays 214 (e.g., x-ray beam 138 of FIG. 1) emitted from source 204, through patient and table (not shown) and received at detector 202.

Referring now to FIG. 3, a typical image sequence is described. At a selected frame rate, an x-ray image is obtained. In one embodiment the frame rate is about fifteen frames per second (15 fps), but is not limited thereto, where each image includes two (2) or more sub-images. A first sub-image 300 is generated within a few ms at a lower kV value 302 compared to a second sub-image 304 generated at a higher kV value 306 in an exemplary image sequence. In one embodiment, the differential between the first and second kV values is between about 10 kV to about 50 kV, and more preferably between about 30 to about 50 kV.

In one embodiment, the tube current is switched off (e.g., grid switched) with a very steep downflank indicated generally at 310 with respect to a current plot 312 of tube current vs. time. Furthermore, when the tube current is switched off, the tube voltage increases to the higher kV value 306 indicated generally with sloped segment 314 intermediate lower and higher values 302 and 306, respectively, in a voltage plot 316 of tube voltage versus time. Voltage plot 316 indicates durations of a low kV first pulse 318 and a high kV second pulse 320 corresponding to the lower and higher kV values 302 and 306, respectively. A pixel plot versus time plot at 324 indicates first and second signals corresponding to the first and second sub-images as integrations of the first and second pulses 318 and 320, respectively.

The integrated first signal corresponding to the first sub-image 300 is transferred to a sample and hold (S&H) node for each pixel of the CMOS based FD 202 indicated generally at 330 and reset at 332 in less than about 0.1 ms. However, in any case, resetting the detector 202 should be less than 10 ms, and more preferably less than about 1 ms. As soon as the tube current is zero, the tube voltage is increased (see positive sloped segment 314) to the preset higher kV value 306 in preferably less than about 1 ms. The higher kV value 306 is about 20 kV higher than the lower kV value 302 of the first sub-image 300 in an exemplary embodiment. However, other kV differential values between the lower and higher kV values 302 and 306 are contemplated suitable to the desired end purpose. In addition, although the tube current is described as dropping to zero, it is not required, as it is also possible to maintain the current and increase the tube voltage.

At the moment system 200 is in the condition of zero tube current, FD 202 is ready to acquire a new sub-image, X-ray source 204 is switched to the higher kV value setting and the first sub-image 300 is read-out as indicated generally at 336 in a plot 340 of a pixel S&H versus time. The second signal corresponding to the second image 304 is then immediately integrated at 342 at the higher kV value 306 in parallel with first sub-image 300 being read-out. At this kV value 306 the tube current should be lower than the tube current at the lower kV value 302 to reduce the dose at the higher kV value 306, as indicated in tube current plot 312. Alternatively, the width of pulse 320 or duration of the higher kV value 306 may be set at a shorter timeframe. In a further alternative embodiment, a reduction in both the tube current and duration of the higher kV value 306 may be employed to reduce the dose at the higher kV value 306.

The delay between the two sub-images 300 and 304 should be as short as possible, and preferably shorter than about 1 ms. After switching off the tube current, the second sub-image 342 remains stored on each pixel generally indicated at 342. After the read-out of the first sub-image 336 is finished, the integrated signal corresponding to the second image 342 is transferred to the S&H node for each pixel indicated generally at 360 and the second sub-image 364 is then read-out. The time required for reading out the first image 336 usually depends on the binning mode of the detector 202.

In an alternative embodiment the tube current to the x-ray tube is not switched to zero but is maintained at approximately the same level during acquisition of 2 or more sub-images. The integration of the first sub-image in FD 202 is then stopped in the period when the tube voltage is being switched from the lower to the higher value. The integrated signal from the first sub-image is then switched to the S&H nodes, the detector 202 is reset and the integration of the second sub-image is started. In this case the time between ending the integration of the first sub-image and starting integration of the second sub-image should be very short (e.g., less than 1 millisecond and preferably less than 0.1 millisecond) since the x-ray dose to the patient is not used for imaging during this period.

The total time required for the two sub-images 336, 364 needs to be short (e.g., preferably shorter than about 10 ms) so that the movement of the anatomical image target, e.g., the arteries of the heart, do not blur the images. The two sub-images 336, 364 are then used to obtain the maximum contrast to show for example, vulnerable plaque in the arteries. Maximizing the contrast is done either by subtraction or by dividing the two sub-images 336, 364. Depending on the total time required to generate the two sub-images, the subtracted sub-images 336, 364 will be able to illustrate improved results depending on the rate of movement of the imaged tissue (e.g. the arteries of the heart). Further, the total time required to generate the two images and the rate of movement of the imaged tissue determines during which phases of anatomical movement (e.g., phases of heart movement) that dual energy images can be generated.

The control of the dose in each of the sub-images can be improved by using the integrated dose sensing option of the CMOS FD 202. The switching off of the tube current can then be controlled on a sub-millisecond time scale to optimize the dose per each subframe for obtaining optimum subtracted images for every dose level. This use of sub-images acquired at very small time intervals at different kV values of the X-ray source greatly improves contrast in tissue without using a contrast medium. Alternatively, the contrast may be improved using less contrast medium than is used normally used. In cardio applications, for example, it leads to a much improved visualisation of the target tissue, e.g., vulnerable plaque in cardiac arteries.

The present disclosure can be implemented in an x-ray imaging system to improve contrast without using a contrast medium or using less. In particular, dynamic dual energy x-ray imaging of a subject, such as in cardio/vascular applications is implemented using a very fast x-ray detector that uses parallel signal integration and read-out in combination with an x-ray source and control for very fast adaptation of the kV value of the x-ray tube and acquisition of the images with different tube conditions on a millisecond timescale. The detector also includes an integrated dose sensing mode (operation of a frame rate of as high as 10,000 fps in a course pixel mode while the actual image is integrated in the desired pixel size). The functional application of the present disclosure allows dual energy dynamic imaging by increasing the speed of image acquisition, dose control and image read-out.

In sum, the disclosed system, apparatus and method provide significant benefits to users of dual energy x-ray imaging systems, particularly physicians desiring increased image contrast when imaging cardio/vascular structures to determine the presence of vulnerable plaque in arteries visible in real time. In this manner, the use of dual energy sub-images acquired in parallel with read-out at very small time intervals at different kV values of the x-ray source leads to improved contrast in tissue without contrast medium or with using less.

Although the system and method of the present disclosure have been described with reference to exemplary embodiments thereof, the present disclosure is not limited to such exemplary embodiments. Rather, the system and method disclosed herein are susceptible to a variety of modifications, enhancements and/or variations, without departing from the spirit or scope hereof. Accordingly, the present disclosure embodies and encompasses such modifications, enhancements and/or variations within the scope of the claims appended hereto.

1. A system for dual energy imaging in dynamic imaging sequences, the system comprising:
a x-ray source (204) configured for fast adaptation at different kV values of the x-ray source (204);
a flat x-ray detector (202), the detector (202) integrating a first signal corresponding to a first sub-image (300) at a first kV value (302) and a second signal corresponding to a second sub-image (304) at a second kV value (306), the detector (202) providing signal integration of the second sub-image (134) in parallel with read-out of the first sub-image (300); and
a x-ray controller (206) in operable communication with the x-ray detector (202) and x-ray source (204), the x-ray controller (206) controlling generation of x-ray pulses in the x-ray source (204) and acquisition of images with the x-ray source (204) generating the x-ray pulses at different kV values on a millisecond timescale.

2. The system of claim 1, wherein the detector (202) is a single full area pixelated CMOS imager.

3. The system of claim 1, further comprising:
a buffer storage node in which an integrated signal for each pixel of the detector (202) is stored synchronously for a total image of the first sub-image (300) of the imaging sequence after which the detector is reset and the detector integrates the second signal corresponding to the second sub-image (304).

4. The system of claim 3, wherein after read-out of the first sub-image (300) and integration of the second sub-image (304) are both completed, the second sub-image is transferred to the storage node, the detector is reset and the second sub-image (304) is read-out from the storage node in parallel with another sub-image being integrated for each pixel of the detector (202).

5. The system of claim 1, wherein the detector (202) includes an integrated dose sensing mode, the integrated dose sensing mode includes operation at a frame rate of as high as about 10,000 fps in a coarse pixel mode while an actual image is integrated in a desired pixel size.

6. The system of claim 5, wherein control of the dose in each of the sub-images is controlled using the integrated dose sensing mode.

7. The system of claim 1, wherein a differential between the first and second kV values of the x-ray source (204) is rapidly varied on an order of magnitude of about 5 kV/ms to about 100 kV/ms.

8. The system of claim 1, wherein the x-ray source (204) includes a x-ray tube (132) and generator, the x-ray source (204) includes at least one of the following properties:
a tube voltage of the x-ray tube (132) is variable on a millisecond timescale or on a sub-millisecond timescale; and
a tube current of the x-ray tube (132) is switchable ON/OFF supplying a desired x-ray dose at different kV values.

9. The system of claim 8, wherein the first sub-image (300) is generated in about a few milliseconds at the first kV value (302) to generate the first sub-image (300) and the second sub-image (304) is generated by increasing the tube voltage to a preset second kV value (306) of about 10 kV to about 50 kV higher than the first kV value (302).

10. The system of claim 9, wherein at the moment the x-ray tube (132) is at the second kV value (306), the detector (202) is ready to acquire the second sub-image (304) in parallel to the first image (300) being read-out.

11. The system of claim 10, wherein a delay between the first (300) and second sub-images (304) is less than about 1 millisecond.

12. The system of claim 10, wherein after the read-out of the first sub-image (300) and integration of the second sub-image (3044) are both completed, the integrated second signal corresponding to the second sub-image (304) is transferred to a sample and hold node from each pixel of the detector and the second sub-image (304) is read-out.

13. The system of claim 12, wherein a time required for completion of read-out of the first sub-image (300) is dependent on a binning mode of the detector (202).

14. The system of claim 1, wherein the x-ray controller (206) one of subtracts and divides the first and second sub-images providing improved contrast in tissue without using a contrast medium or using less contrast medium.

15. A method of dual energy dynamic x-ray imaging, the method comprising:
obtaining images at a selected frame rate, each image includes a first sub-image (300) and a second sub-image (304);
integrating a first signal corresponding to the first sub-image (300) in a few milliseconds at a first kV value of the x-ray tube (302);
transferring the integrated first signal corresponding to the first sub-image (300) to a sample and hold node for each pixel of a CMOS flat detector (202);
increasing an x-ray tube voltage to a preset second kV value (306) higher than the first kV value (302);
resetting the detector (202) in less than about 1 milliseconds; and
reading out the first image (300) while the second kV value (306) is obtained and in parallel with the flat detector (202) integrating a second signal corresponding to the second sub-image (304).

16. The method of claim 15, wherein the first (300) and second sub-images (304) are one of subtracted and divided providing improved contrast in tissue without using a contrast medium or using less contrast medium.

17. The method of claim 15, wherein when the second sub-image (304) is generated at the second kV value (306) higher than the first kV value (302), at least one of the tube current at the second kV value (306) is lower than the tube current at the first kV value (302) and duration of the tube current at the second kV value (306) is reduced to reduce dose at the higher second kV value (306).

18. The method of claim 15, wherein a delay between generating the first (300) and second sub-images (304) is less than about 1 millisecond.

19. The method of claim 15, wherein a total time required for obtaining the first (300) and second sub-images (304) is less than about 10 milliseconds.

20. The method of claim 15, wherein the first (300) and second sub-images (304) are images of a human heart.

21. The method of claim 20, wherein the first (300) and second sub-images (304) reveal vulnerable plaque in arteries of the heart.
